(19) United States
(12) Patent Application Publication
(10) Pub. No.: US 2023/0250031 A1
(43) Pub. Date: Aug. 10, 2023

(54) MULTIFUNCTIONAL CEMENT ADDITIVES AND METHODS OF USING SAME

(71) Applicant: Solugen, Inc., Houston, TX (US)

(72) Inventors: Jun Su An, Houston, TX (US); Frederyk Ngantung, Los Angeles, CA (US); Abdul Siraj, Sugar Land, TX (US); LoongYi Tan, Houston, TX (US)

(73) Assignee: Solugen, Inc., Houston, TX (US)

(21) Appl. No.: 18/011,277

(22) PCT Filed: Jul. 7, 2021
(86) PCT No.: PCT/US21/40609

§ 371 Date: Dec. 19, 2022

Related U.S. Application Data
(60) Provisional application No. 63/050,097, filed on Jul. 9, 2020.

(51) Int. Cl. C04B 40/00; C04B 24/16; C04B 28/02

(52) U.S. Cl. CPC C04B 40/0039; C04B 24/16; C04B 28/02; C04B 2111/94

(57) ABSTRACT

A multifunctional cement additive includes a biochelant and a solvent. The biochelant includes a sodium glucarate liquid oxidation product including predominantly gluconate and glucarate anions with minor component species of n-keto-acids and C₂-C₅ diacids. A cement composition includes (i) a cementitious material and (ii) a biochelant, and (iii) a solvent. The biochelant includes a sodium glucarate liquid oxidation product including predominantly gluconate and glucarate anions with minor component species of n-keto-acids and C₂-C₅ diacids.

### CROSS-REFERENCE TO RELATED APPLICATIONS

This application is a 35 U.S.C. § 371 national stage application of PCT/US2021/040609 filed Jul. 7, 2021, and entitled “Multifunctional Cement Additives and Methods of Using Same,” which claims the benefit of U.S. provisional patent application Ser. No. 63/050,097 filed Jul. 9, 2020, and entitled “Cement Additive Compositions and Methods of Using Same,” each of which is hereby incorporated herein by reference in its entirety for all purposes.

### FIELD

The present disclosure relates generally to compositions and methods for use with materials that form a hardened mass when hydrated. More particularly, the present disclosure relates to cement additives and methods of using same.

### BACKGROUND

Cement additives are generally described as chemicals and/or materials added to a cement slurry to modify the characteristics of the slurry or the set cement. The present disclosure refers to cement additives, however, the materials disclosed herein may confer similar functionality to concrete.

Cement additives may be broadly divided into six different categories that include: (i) water reducers, (ii) set retarders, (iii) accelerants, (iv) superplasticizers, (v) corrosion inhibitors, and (vi) air entrainers. Currently, many cement and/or concrete admixtures contain cement additives that are single or dual functionality products. For example, lignosulfonates are chemicals that are conventionally employed as both a set retarder and plasticizer.

### SUMMARY

Disclosed herein is a multifunctional cement additive comprising a biochelant; and a solvent; wherein the biochelant comprises a sodium glucarate liquid oxidation product comprising predominantly gluconate and glucarate anions with minor component species of n-keto-acids and C₂-C₅ diacids.

Also disclosed herein is a cement composition comprising (i) a cementitious material (ii) a biochelant wherein the biochelant comprises a sodium glucarate liquid oxidation product comprising predominantly gluconate and glucarate anions with minor component species of n-keto-acids and C₂-C₅ diacids, and (iii) a solvent.

### BRIEF DESCRIPTION OF THE DRAWINGS

For a detailed description of the aspects of the presently disclosed subject matter, reference will now be made to the accompanying drawings in which:

FIG. 1 is a graph illustrating the consistency of the samples from Example 1 as function of time.

FIG. 2 is a bar graph depicting the conductivity of the samples from Example 2.

FIG. 3 is a graph illustrating the compressive strength as a function of time for the medium alkali cements of Example 3.

FIG. 4 is a graph illustrating the compressive strength as a function of time for the low alkali cements of Example 3.

FIG. 5 is a graph of the compressive strength as a function of time for the HOLCIM cements of Example 3.

FIG. 6 is a bar graph depicting the set times of the samples comprising a medium alkali cement from Example 3.

FIG. 7 is a bar graph depicting the set times of the samples comprising a low alkali cement from Example 3.

FIG. 8 is a bar graph depicting the set times of the samples comprising a HOLCIM cement from Example 3.

FIG. 9 is a bar graph depicting the slump times of the samples from Example 3.

### DETAILED DESCRIPTION

As previously described, many cement additives are single or dual functionality products. For example, lignosulfonates are chemicals that are conventionally employed as both a set retarder and plasticizer. A widely used chemical additive comprising gluconate and/or glucoheptonate also exhibits dual functionality. A challenge to the use of these materials is that being limited to single or dual functionalities, multiple additional materials are needed to provide cementitious compositions having tailored, application-desired properties. Accordingly, an ongoing need exists for novel additives for use in cement and/or concrete that exhibit higher levels of functionality.

Disclosed herein are compositions for use as cement additives. In an aspect, the cement additives of the present disclosure are multifunctional cement additives having at least three functionalities selected from the group consisting of water reducers, set retarders, accelerants, superplasticizers, corrosion inhibitors, and air entrainers. Herein, these materials are referred to as “cement additives with higher functionality” or CAHF. In general, cements including CAHFs can be used in a variety of applications. One exemplary application suitable for cements including CAHFs is in oil and gas completion operations such as the cementing of casing in position within a borehole.

In an aspect, the CAHF comprises a chelant. Herein a chelant, also termed a sequestrant or a chelating agent, refers to a molecule capable of bonding a metal. The chelating agent is a ligand that contains two or more electron-donating groups so that more than one bond is formed between atoms on the ligand to the metal. This bond can also be dative or a coordinating covalent bond meaning the electrons from each electronegative atom provides both electrons to form the bond to the metal center. In an aspect, the chelant is a biochelant. As used herein, the prefix “bio” indicates that the chemical is produced by a biological process such as by using an enzyme catalyst.

In an aspect, the biochelant comprises aldonic acid, uronic acid, aldaric acid or a combination thereof, and a counter cation. The counter cation may comprise an alkali metal (Group I), an alkali earth metal (Group II) or a combination thereof. In certain aspects, the counter cation is sodium, potassium, magnesium, calcium, strontium, cesium or a combination thereof.

In an aspect, the biochelant comprises a glucose oxidation product, a gluconic acid oxidation product, a gluconate or a combination thereof. The glucose oxidation product, gluconic acid oxidation product, gluconate or a combination thereof may be buffered to a suitable pH. Buffering can be carried out using any suitable methodology such as by using a pH adjusting material in an amount of from about 1 weight percent (wt. %) to about 10 wt. %, alternatively from about 1 wt. % to about 3 wt. %, or alternatively from about 5 wt. % to about 9 wt. % based on the total weight of the biochelant. In an aspect, the biochelant comprises from about 1 wt. % to about 8 wt. % of a caustic solution in a 20 wt. % gluconate solution.

Alternatively, the biochelant comprises a buffered glucose oxidation product, a buffered gluconic acid oxidation product or combinations thereof. In such aspects, the buffered glucose oxidation product, the buffered gluconic acid oxidation product or the combination thereof is buffered to a suitable pH such as from about 6 to about 7, using any suitable acid or base. In such aspects, the biochelant comprises a mixture of gluconic acid and glucaric acid and further comprises a minor component species comprising n-keto-acids, C₂-C₆ diacids or a combination thereof. In an aspect, the biochelant comprises BIOCHELATE™ metal chelation product commercially available from Solugen Inc., Houston Tex.

In an aspect, the chelant is present in the CAHF in an amount of from about 0.1 weight percent (wt. %) to about 40 wt. % based on the total weight of the CAHF, alternatively from about 0.1 wt. % to about 20 wt. % or alternatively from about 20 wt. % to about 40 wt. %.

CAHFs of the type disclose herein may be used as a cement additive that functions as a water reducer, a set retarder, an accelerant, a superplasticizer; a corrosion inhibitor, an air entrainer, or any combination thereof.

In an aspect, the CAHF functions as a water reducer in the absence of other conventional water reducers. Herein, a water reducer refers to a material that is able to reduce the water:cement ratio of a cementitious composition without adversely affecting the rheological properties of the slurry. Water reducers can decrease the concrete porosity, increase the concrete strength, increase the workability of the cement slurry, reduce the water permeability of the set cement, and reduce the diffusivity of aggressive agents in the concrete thereby improving the durability of concrete and providing a better surface finish.

In some aspects, the CAHF is included in the cement with conventional water reducers such as lignosulfates and hydroxycarboxylic acids.

In an aspect, the CAHF functions as a set retarder in the absence of other conventional set retarders. Herein, a set retarder refers to a material used to increase the thickening time of cement slurries to enable proper placement. The need for cement retardation increases with depth due to the greater time required to complete the cementing operation and the effect of increased temperature on the cement-setting process.

In some aspects, the CAHF is included in the cement with conventional set retarders such as lignosulfonates, welan gum, xanthan gum, cellulose, polyanionic cellulose, organic acids, alkali metal salts of organic acids, carboxy hexoses and the corresponding lactones, polyvalent metal salts (e.g., polyvalent metal halides), and the like.

In an aspect, a CAHF of the type disclosed herein increases the thickening time of the cement by from about 5% to about 400%, alternatively from about 100% to about 400%, alternatively from about 5% to about 50% or alternatively from about 40% to about 200% when compared to an otherwise similar cementitious composition lacking a CAHF. In an aspect, a CAHF of the type disclosed herein has a thickening time of from about 2 hours (hrs) to about 34 hrs, alternatively from about 2 hrs to about 8 hrs, alternatively from about 4 hrs to about 30 hrs or alternatively from about 6 hrs to about 34 hrs as determined in accordance with API RP 10B-2 clause 9 and ASTM C403.

In an aspect, the CAHF functions as an accelerant in the absence of other conventional accelerants. Herein, an accelerant refers to a material used to reduce the time required for the set cement to develop compressive strength sufficient to enable operations to continue. Accelerators are generally used in near-surface applications in which the temperature is relatively low. In some aspects, the CAHF is included in the cement with conventional accelerants such as calcium nitrite, calcium nitrate, calcium chloride, calcium formate, or tricalcium silicate.

In an aspect, a CAHF of the type disclosed herein reduces the setting time of the cement by from about 20% to about 90%, alternatively from about 40% to about 80%, alternatively from about 60% to about 90% or alternatively from about 20% to about 50% when compared to an otherwise similar cementitious composition lacking a CAHF as determined in accordance to API RP 10B-2 clause 9 and ASTM C₄₀₃.

In an aspect, the CAHF functions as a superplasticizer in the absence of other conventional superplasticizers. Herein, a superplasticizer, also known as a high range water reducer, refers to a material that (i) enables the production of cement with a reduction in water content of 30% or more and (ii) retard curing of the cement. Superplasticizers are used where a well-dispersed particle suspension is desired to improve the slurry rheology. Their addition to cementitious compositions allows the reduction of the water to cement ratio without negatively affecting the workability of the mixture, and enables the production of self-consolidating cementitious compositions and high-performance cementitious compositions. In some aspects, the CAHF is included in the cement with conventional superplasticizers such as phosphonic acid-terminated polyethers and naphthalenesulfonate/formaldehyde polymer.

In an aspect, the CAHF functions as a corrosion inhibitor in the absence of other conventional corrosion inhibitors. Herein, a corrosion inhibitor refers to a material used to protect metal-containing components (e.g., iron-containing, steel-containing) in an operation from degradation by caustic materials. As the CAHF comprises a diacid, it may provide corrosion resistance to metal surfaces by binding to metal surfaces, and passivating and forming a corrosion resistant film. The CAHF can also solubilize and keep metal cations in solution; providing a higher concentration of metals in solution. A higher concentration of metal ions in solution leads to a lower effective concentration gradient, which will thereby limit and decrease the mass transfer rate and corrosion rate from the solid metal to the aqueous or colloidal phase. The use of a CAHF of the type disclosed herein as a corrosion inhibitor may result in economic advantages such as reduction in material costs, increased batching time, and may display enhanced compatibility when using carrying out operations in warmer climates. In some aspects, the CAHF is included in the cement with conventional corrosion inhibitors such as nitrites and nitrates.

In an aspect, a CAHF of the type disclosed herein functions as a corrosion inhibitor of the cement by reducing the conductivity of the cement by from about 10% to about 10000%, alternatively from about 400% to about 800%, alternatively from about 600% to about 10000% or alternatively from about 10% to about 500% when compared to an otherwise similar cementitious composition lacking a CAHF. In an aspect, a CAHF of the type disclosed herein has a conductivity of from about 0.1 μS/cm² to about 25 μS/cm², alternatively from about 0.1 μS/cm² to about 1 μS/cm², alternatively from about 2 μS/cm² to about 25 μS/cm² or alternatively from about 1 μS/cm² to about 20 μS/cm² as determined in accordance with ASTM G180 Polarization Resistance Test.

In an aspect, the CAHF functions as an air entrainer in the absence of other conventional air entrainers. Herein, an air entrainer refers to a material that facilitates the intentional creation of air bubbles in concrete. The air bubbles are created during mixing of the easy flowing, not hardened concrete, and most of them survive to be part of the hardened concrete. The primary purpose of air entrainment is to increase the durability of the hardened concrete, especially in climates subject to freeze-thaw, and to increase workability of the concrete while in a plastic (flowing) state. In some aspects, the CAHF is combined with conventional air entrainers such as natural wood resins, animal fats, wetting agents, and water-soluble soaps of certain acids.

In an aspect, the CAHF is added to a cement or cementitious composition comprising a hydraulic cement. Hydraulic cements generally comprise calcium oxide, silicon dioxide, aluminum oxide, ferric oxide, and sulfur oxide, and harden by reaction with water. Nonlimiting examples of hydraulic cements suitable for use in the present disclosure include Portland cements (e.g., classes A, B, C, G, and H Portland cements), pozzolana cements, gypsum cements, phosphate cements, high alumina content cements, silica cements, high alkalinity cements, shale cements, acid/base cements, magnesia cements such as Sorel cements, fly ash cement, zeolite cement systems, cement kiln dust cement systems, slag cements, micro-fine cement, metakaolin, and combinations thereof. In an aspect, the cement is a Portland cement, which is a mixture of calcium oxide, silicon dioxide, aluminum oxide, ferric oxide, and sulfur oxide.

In one or more aspects, the CAHF is present in the cementitious material in a range of 0.01 to 5% by weight of cement (BWOC), alternatively from about 0.1% to about 5%, alternatively from about 0.1% to about 1% or alternatively from about 2% to about 5%.

In an aspect, the cementitious composition includes a sufficient amount of an aqueous fluid to form a pumpable cement slurry. The aqueous fluid may be fresh water or salt water, e.g., an unsaturated aqueous salt solution or a saturated aqueous salt solution such as brine or seawater. In an aspect, the aqueous fluid may be present within the cement slurry in an amount of from about 20% to about 180% BWOC, alternatively from about 28% to about 60% BWOC, or alternatively from about 36% to about 66% BWOC.

In an aspect, a cementitious slurry may be prepared by combining the cementitious material, aqueous fluid and CAHF. These components may be combined using any mixing device compatible with the composition, for example a bulk mixer. In an aspect, the cementitious material, aqueous fluid and CAHF are combined at the jobsite or the site of intended use (e.g., at the well site where the completion operation is being performed). This site may include construction sites, mixing sites, or at an oil gas wellbore. Alternatively, the cementitious material aqueous fluid and CAHF are combined off-site and then later used at the site of intended use or jobsite (e.g., a well site). For example, the CAHF may be dry blended with the dry cement at a location remote from the jobsite, subsequently transported to the well site and formed into a pumpable slurry, and placed. For example, the cementitious composition with the CAHF may be placed in a construction location, or down a wellbore at the well site. Alternatively, the CAHF is added as an aqueous solution (e.g., concentrate) to the mix water that is later contacted with the cementitious material. Alternatively, the CAHF is formulated as an aqueous emulsions/dispersion that may be injected into the slurry during the cementing operation.

In an aspect, the CAHF when added to a cement slurry results in an increase in the compressive strength of the set cement when compared to a set cement lacking a CAHF. In an aspect, the compressive strength of the set cement is increased by from about 5% to about 100%, alternatively from about 10% to about 50% or, alternatively from about 5% to about 30%. In an aspect, the set cement comprising a CAHF of the type disclosed herein has a compressive strength of from about 500 psi to about 8000 psi, alternatively from about 5000 psi about 8000 psi, alternatively from about 500 psi to about 3000 psi or alternatively from about 2000 psi to about 6000 psi as determined in accordance with ASTM C39.

In an aspect, a cement slurry comprising a CAHF of the type disclosed herein has an increase in slump of from about 0.5 inches (in.) to about 9 in. alternatively from about 1 in. to about 5 in., alternatively from about 0.5 in. to about 3 in., or alternatively from about 3 in. to about 7 in. In an aspect, a cement slurry comprising a CAHF of the type disclosed herein has a slump of from about 5.6 in. to about 9 in., alternatively from about 7 in. to about 9 in., alternatively from about 6 in. to about 8 in., or alternatively from about 5.6 in. to about 7.2 in. as determined in accordance with ASTM C31.

The CAHF disclosed herein is a multifunctional admixture that functions as a water reducer, set retarder, air entrainer, accelerant, a superplasticizer or a combination thereof. Additionally, the CAHF may also function as a corrosion inhibitor, which may reduce or eliminate the use of nitrites, lignosulfonates, and other carboxylic acids as cement property modifiers.

Furthermore, a CAHF of the type disclosed herein is a readily biodegradable product obtained from an enzymatic process. This is in sharp contrast to conventional cement additives such as lignosulfonates, which commonly go through a process where sulfuric or nitric acid is introduced, producing environmentally detrimental sulfate or nitrate-based waste. Use of a CAHF of the type disclosed herein is anticipated to reduce the amount of nitrites, nitrates, and sulfate products that are manufactured, leading to a lower carbon footprint, as well as ancillary benefits such as lower nitrate/nitrite wastewater discharge.

The use of CAHF of the type disclosed herein is also advantageous over incumbents such as lignosulfonate, as the irregularity of lignosulfonates, for example in their molecular weight distribution or crosslinking, can lead to unpredictable performance such as the sludging of lignosulfonates. The molecular weight of a CAHF of the type disclosed herein is tightly controlled thereby minimizing sludging effects.

Further, a CAHF of the type disclosed herein is very flexible in terms of its compatibility and can also be combined with existing corrosion inhibitors, set retarders, water reducers, air entrainers, accelerators and superplasticizers, as desired. to further enhance their performance.

### Additional Disclosure

The following are non-limiting, specific aspects in accordance with the present disclosure:

A first aspect which is a composition for a retarded cement comprising a chelant; Portland cement and a solvent.

A second aspect which is the composition of the first aspect wherein the chelant comprises an aldonic, uronic, or aldaric acid, or a salt or derivative thereof, or a combination thereof.

A third aspect which is the composition of the first aspect wherein the chelant comprises sodium gluconate and sodium glucarate liquid oxidation product comprising predominantly gluconate and glucarate anions with minor component species of n-keto-acids and C₂-C₅ diacids.

A fourth aspect which is the composition of the first aspect wherein the cement comprises calcium oxide, silicon dioxide, aluminum oxide, ferric oxide, and sulfur oxide.

A fifth aspect which is the composition of the first aspect wherein the solvent comprises water.

A sixth aspect which is a multifunctional cement additive comprising a biochelant; and a solvent; wherein the biochelant comprises a sodium glucarate liquid oxidation product comprising predominantly gluconate and glucarate anions with minor component species of n-keto-acids and C₂-C₅ diacids.

A seventh aspect which is the multifunctional cement additive of the first aspect having a conductivity of from about 10% to about 10000% as determined in accordance with ASTM G180 Polarization Resistance Test.

An eighth aspect which is the multifunctional cement additive of any of the sixth through seventh aspects comprising at least three functionalities selected from the group consisting of water reducers, set retarders, accelerants, superplasticizers, corrosion inhibitors, and air entrainers.

A ninth aspect which is the multifunctional cement additive of any of the sixth through eighth aspects further comprising a water reducer.

A tenth aspect which is the multifunctional cement additive of the ninth aspect wherein the water reducer comprises lignosulfates, hydroxycarboxylic acid or a combination thereof.

An eleventh aspect which is the multifunctional cement additive of any of the sixth through tenth aspects further comprising a set retarder.

A twelfth aspect which is the multifunctional cement additive of the eleventh aspect wherein the set retarder comprises lignosulfonates, welan gum, xanthan gum, cellulose, polyanionic cellulose, organic acids, alkali metal salts of organic acids, carboxy hexoses, carboxy lactones, polyvalent metal salts or a combination thereof.

A thirteenth aspect which is the multifunctional cement additive of any of the sixth through twelfth aspects further comprising an accelerant.

A fourteenth aspect which is the multifunctional cement additive of the thirteenth aspect wherein the accelerant comprises calcium chloride, tricalcium silicate or a combination thereof.

A fifteenth aspect which is the multifunctional cement additive of any of the sixth through fourteenth aspects further comprising a superplasticizer.

A sixteenth aspect which is the multifunctional cement additive of the fifteenth aspect wherein the superplasticizer comprises phosphonic acid-terminated polyethers, naphthalenesulfonate polymer, formaldehyde polymer or a combination thereof.

A seventeenth aspect which is the multifunctional cement additive of any of the sixth through sixteenth aspects further comprising a corrosion inhibitor.

An eighteenth aspect which is the multifunctional cement additive of the seventeenth aspect wherein the corrosion inhibitor comprises nitrites, nitrates or a combination thereof.

A nineteenth aspect which is the multifunctional cement additive of any of the sixth through eighteenth aspects further comprising an air entrainer.

A twentieth aspect which is the multifunctional cement additive of the nineteenth aspect wherein the air entrainer comprises natural wood resins, animal fats, wetting agents, water-soluble acid soaps or a combination thereof.

A twenty-first aspect which is a cement composition comprising (i) a cementitious material (ii) a biochelant wherein the biochelant comprises a sodium glucarate liquid oxidation product comprising predominantly gluconate and glucarate anions with minor component species of n-keto-acids and C₂-C₅ diacids; and (iii) a solvent;

A twenty-second aspect which is the cement composition of the twenty-first aspect wherein the cementitious material comprises Portland cements, pozzolana cements, gypsum cements, phosphate cements, high alumina content cements, silica cements, high alkalinity cements, shale cements, acid/base cements, magnesia cements such as Sorel cements, fly ash cement, zeolite cement systems, cement kiln dust cement systems, slag cements, micro-fine cement, metakaolin, or a combination thereof.

A twenty-third aspect which is the cement composition of any of the twenty-first through twenty-second aspects wherein the cementitious material is present in an amount of from about 0.01% BWOC to about 5% BWOC.

A twenty-fourth aspect which is the cement composition of any of the twenty-first through twenty-third aspects wherein the biochelant is present is an amount of from about 0.1 wt. % to about 40 wt. % based on the total weight of the cement composition.

A twenty-fifth aspect which is the cement composition of any of the twenty-first through twenty-fourth aspects wherein the solvent comprises fresh water or salt water.

A twenty-sixth aspect which is the cement composition of any of the twenty-first through twenty-fifth aspects wherein the water is present in an amount of from about 20% BWOC to about 180% BWOC.

A twenty-seventh aspect which is the cement composition of any of the twenty-first through twenty-sixth aspects having a compressive strength that is increased by from about 5% to about 100% when compared to an otherwise similar cement composition lacking a biochelant.

A twenty-eighth aspect which is the cement composition of any of the twenty-first through twenty-seventh aspects having a thickening time that is increased by from about 5% to about 400% when compared to an otherwise similar cement composition lacking a biochelant.

A twenty-ninth aspect which is the cement composition of any of the twenty-first through twenty-eighth aspects having a slump that is increased by from about 0.5 inches to about 9 inches when compared to an otherwise similar cement composition lacking a biochelant.

### EXAMPLES

The presently disclosed subject matter having been generally described, the following examples are given as particular aspects of the subject matter and to demonstrate the practice and advantages thereof. It is understood that the examples are given by way of illustration and are not intended to limit the specification or the claims in any manner.

### Example 1

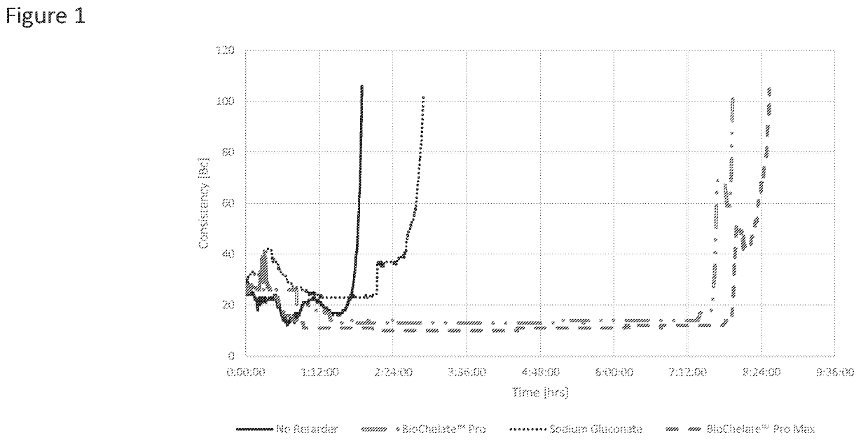

The ability of a CAHF of the type disclosed herein to function as a cement retarder was investigated. The CAHF used as retarder additives were from the BIOCHELATE™ product line of Solugen Inc. Specifically, the thickening time tests were carried out on cement compositions with a base blend having 16.4 ppg Class H slurry, 35% BWOC silica flour, 0.25% BWOC of the dispersant poly naphthalene sulfonate (by weight of cement). 0.60% BWOC of the fluid loss agent which was a cellulose product and 0.180 gal/sack retarder additive. The test conditions were a target pressure of 6656 psi and a target temperature of 250° F. in accordance with API RP 10B-2 clause 9 In accordance with industry standards, 70 Bearden units of consistency (Bc) was used as the metric in which a cement is determined to be “set”. The results are presented in Table 1 and a graph of consistency as a function of time is presented in FIG. 1.

TABLE 1

| | | 50 Bc @ | 70 Bc @ | 100 Bc @ |
|---|---|---|---|---|
| Blend | Initial Bc | HH:MM | HH:MM | HH:MM |
| No retarder | 24 | 01:49 | 01:51 | 01:53 |
| Sodium gluconate | 29 | 02:39 | 02:48 | 02:53 |
| BIOCHELATE ™ PRO | 29 | 07:39 | 07:54 | 07:56 |
| BIOCHELATE ™ PRO | 27 | 07:59 | 08:25 | 08:31 |
| MAX | | | | |

BIOCHELATE™ PRO is a mixture of glucaric acid, sodium glucarate, gluconic acid and sodium while BIOCHELATE™ PRO MAX is a glucaric acid mixture. Referring to both Table 1 and FIG. 1, a composition having a CAHF of the type disclosed herein (BIOCHELATE™ PRO and BIOCHELATE™ PRO MAX products) out-performed the retarding performance of sodium gluconate.

The blends described in Table 1 were further tested using a non-destructive sonic test to determine the compressive strength of the blends. Table 2 lists the results of the sonic test after the cement slurry was cured at 24 hrs.

TABLE 2

| Blend | Compressive Strength @ 24 hrs [psi] |
|---|---|
| No retarder | 2744 |
| Sodium gluconate | 2161 |
| BIOCHELATE ™ PRO | 2506 |
| BIOCHELATE ™ PRO MAX | 2735 |

Table 2 demonstrates the composition having the sodium gluconate additive led to the lowest compressive strength, while the BIOCHELATE™ PRO and BIOCHELATE™ PRO MAX products displayed a higher compressive strength than sodium gluconate.

### Example 2

The ability of a CAHF of the type disclosed herein to function as a corrosion inhibitor was investigated using the ASTM G180 Polarization Resistance test using 0.5M NaCl. The control used in this example comprised a HOLCIM Portland Cement, type I-II low alkali cement. The cement passed ASTM C₁₄₅₀ and AASHTO M85 for Type I-II cement. The results of this evaluation are presented in Table 3.

TABLE 3

| Parameter | Control | BioChelate ™ Pro @ 0.23 gpy |
|---|---|---|
| E_corr (mV) | −472 | −311.6 |
| R_p (kohms) | 12.27 | 243.4 |
| Area (cm²) | 4.9662 | 4.9662 |
| 1/R_p (μS/cm²) | 16.4 | 0.8 |

The additives were dosed at 0.23 gpy (gallons per cubic yard=1.15 L/m3=8.02 mL/L). Referring to Table 3, a significant reduction of conductivity from the baseline was observed, indicating corrosion inhibition. Additionally, there was an 8× reduction in the conductivity (16.4 to 0.8 us/cm²), indicating BIOCHELATE™ PRO is a corrosion inhibitor.

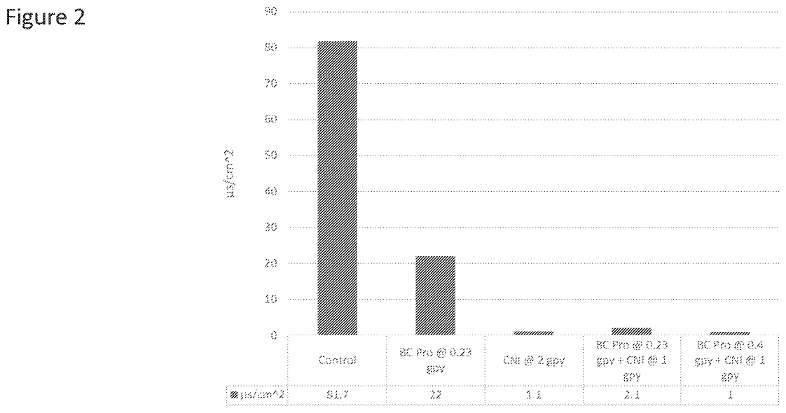

After this test, a modified G180 test was run to further differentiate BIOCHELATE™ PRO. In this test, NaCl was dosed at 1 M vs 0.5 M, which increased the resolution between the runs. The results of this test are presented in FIG. 2. Referring to FIG. 2, the BIOCHELATE™ PRO at 0.23 gpy reduced the conductivity from 81.7 to 22. Additionally, the combination of CNI (Calcium nitrite) with the BIOCHELATE™ PRO products resulted in better performance vs. CNI alone while leading to less overall chemical usage (CNI 2 gpy=1.1 us/cm², whereas BIOCHELATE™ PRO at 0.4 gpy and CNI at 1 gpy=1 us/cm²; while adding a combined total of 1.4 gpy).

### Example 3

The ability of a CAHF of the type disclosed herein (BIOCHELATE™ Products) to improve a cement slurry's compressive strength and act as a set retarder was investigated.

Specifically, the compressive strength of low alkali cements. medium alkali cements, and with a “Holcim Type II” blend was tested in accordance with ASTM C39. The composition of the Holcim Type II blend CEMENT is provided in Table 4 while Table 5 provides the composition for the low alkali cement and Table 6 provides the composition of the medium alkali cement. HOLCIM TYPE II blend is a moderately sulfate resistant Portland cement commercially available from HOLCIM (US) Inc.

TABLE 4
Holcim Type II

| Material | lbs/yd\hat{ }3 |
|---|---|
| Holcim St. Genevieve | 550 |
| Plt. Type II Cement | |
| Agg. Resources | 1239 |
| Midway Pit 2NS Sand | |
| Stone Co Ottawa | 1800 |
| Lake ½″ Limestone | |
| Water | 275 |

TABLE 5
Low Alkali

| Material | lbs/yd\hat{ }3 |
|---|---|
| Larfage Alpena Type | 517 |
| II Low Alkali 0.54% | |
| Agg. Resources | 1528 |
| Midway Pit 2NS Sand | |
| Carmeuse L & St. | 1825 |
| Cedarville #67 Sone | |
| Water | 286 |

TABLE 6
Medium Alkali

| Material | lbs/yd\hat{ }3 |
|---|---|
| St Mary's Type II Med | 517 |
| Alkali | |
| Agg. Resources | 1528 |
| Midway Pit 2NS Sand | |
| Carmeuse L & St. | 1825 |
| Cedarville #67 Stone | |
| Water | 297 |

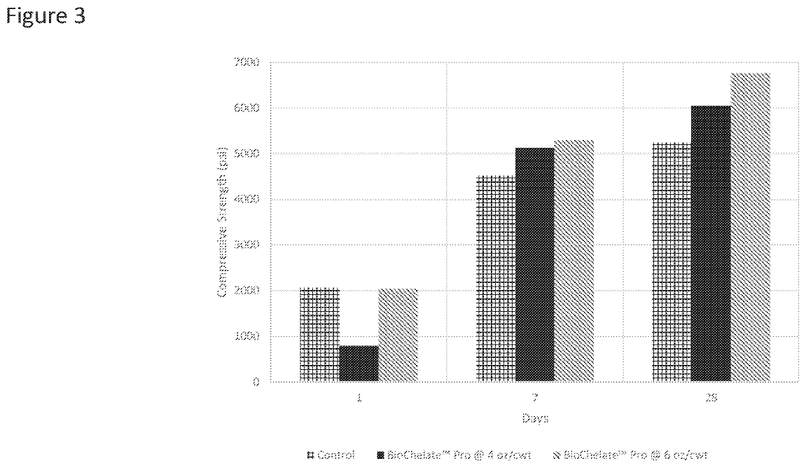

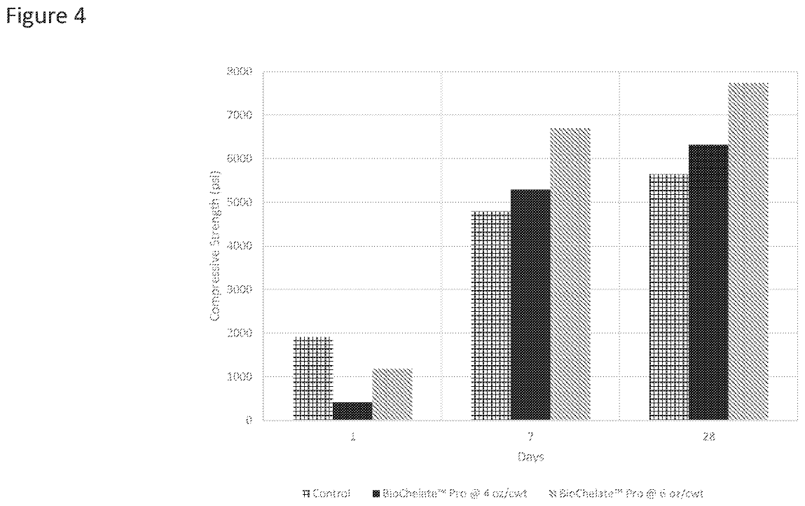

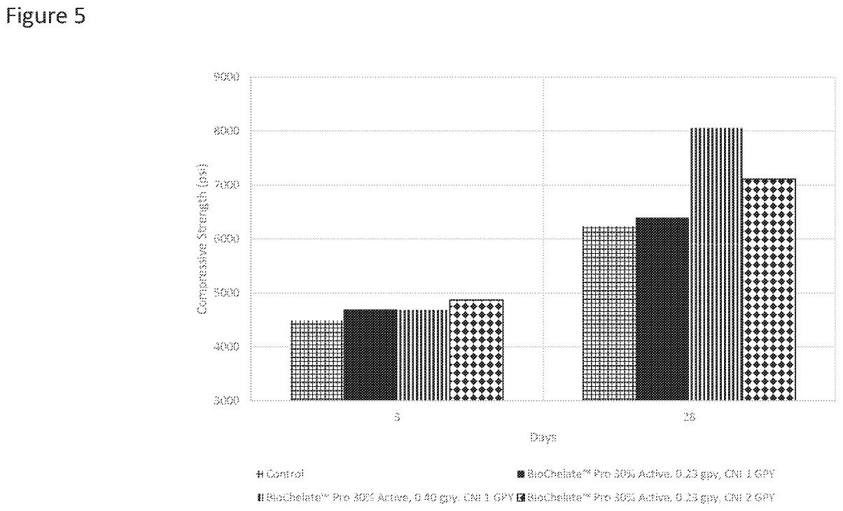

FIG. 3 is a plot of the compressive strength as a function of time for the samples comprising a low alkali cement; FIG. 4 is a plot of the compressive strength as a function of time for the samples comprising a medium alkali cement and FIG. 5 is a plot of the compressive strength as a function of time for the samples comprising a HOLCIM Type II cement. The use of BIOCHELATE™ PRO yielded in higher ultimate compressive strength after approximately 7 days for both medium and low alkali cement. The effect is more pronounced in the low alkali cement, but the use of BIOCHELATE™ PRO yields an increase in the compressive strength of the cement up to 2080 psi. In samples having a mix of CNI and BIOCHELATE™ PRO, the addition of BIOCHELATE™ PRO yielded improved compressive strength with mixtures with CNI.

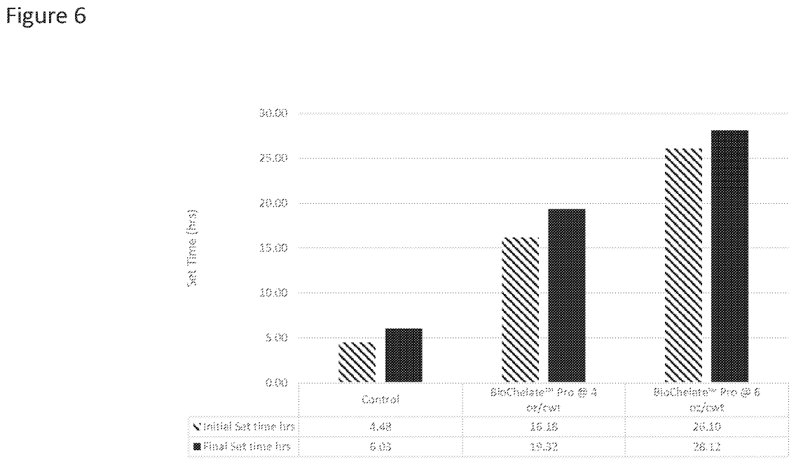

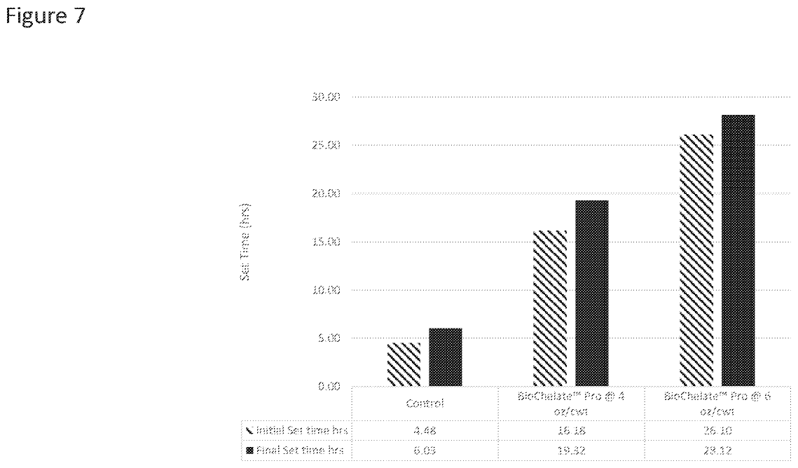

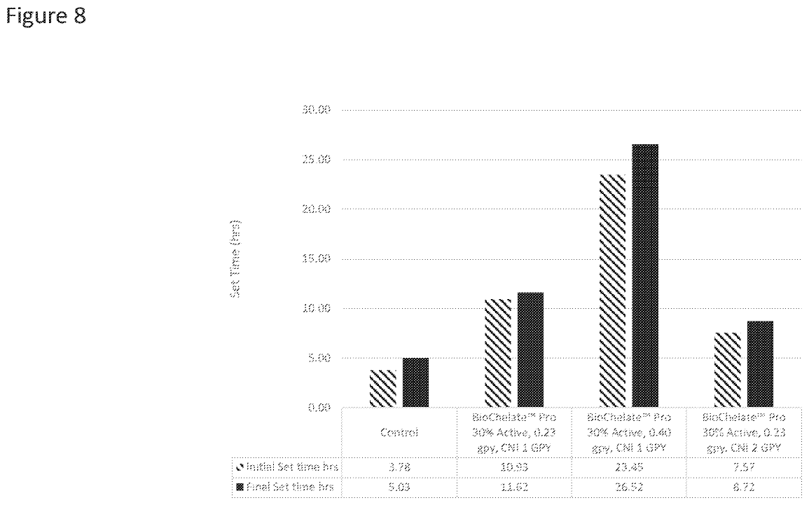

The set time of the samples were determined in accordance with ASTM C₄₀₃ and the results are presented in FIGS. 6, 7 and 8. FIG. 6 is a bar graph of the set time as a function of days for the samples comprising a low alkali cement; FIG. 7 is a bar graph of the set time as a function of days for the samples comprising a medium alkali cement and FIG. 8 is a bar graph of the set time as a function of days for the samples comprising a HOLCIM Type II blend cement. The results demonstrate use of BIOCHELATE™ PRO leads to longer initial and final cement slurry set times, which corroborates the results seen in the oilfield cement testing seen in the API RP 10B-2 Clause 9 testing. Furthermore, these results demonstrate that the BIOCHELATE™ PRO can also mitigate CNI-induced set retardation, as seen in the HOLCIM Type II cement data.

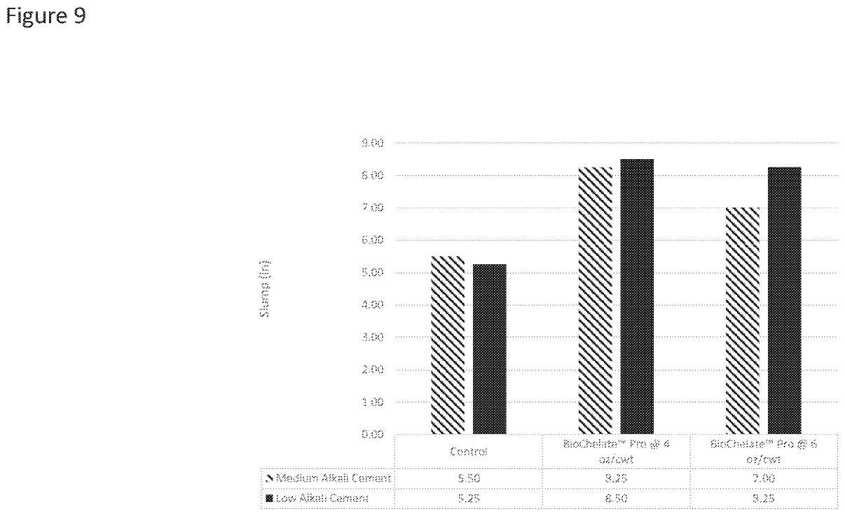

FIG. 9 is a plot of the slump as a function of additive amount for the samples comprising a low alkali cement; a medium alkali cement and a HOLCIM Type II cement. The tests were conducted in accordance with ASTM C₃₁. Referring to FIG. 9, the addition of BIOCHELATE™ PRO yields in higher slump vs. the control, indicating that BIOCHELATE™ PRO also improves slump.

The subject matter having been shown and described, modifications thereof can be made by one skilled in the art without departing from the spirit and teachings of the subject matter. The aspects described herein are exemplary only and are not intended to be limiting. Many variations and modifications of the subject matter disclosed herein are possible and are within the scope of the disclosed subject matter. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). Use of the term “optionally” with respect to any element of a claim is intended to mean that the subject element is required, or alternatively, is not required. Both alternatives are intended to be within the scope of the claim. Use of broader terms such as comprises, includes, having, etc. should be understood to provide support for narrower terms such as consisting of, consisting essentially of, comprised substantially of, etc.

Accordingly, the scope of protection is not limited by the description set out above but is only limited by the claims which follow, that scope including all equivalents of the subject matter of the claims. Each and every claim is incorporated into the specification as an aspect of the present disclosure. Thus, the claims are a further description and are an addition to the aspects of the present invention. The discussion of a reference herein is not an admission that it is prior art to the presently disclosed subject matter, especially any reference that may have a publication date after the priority date of this application. The disclosures of all patents, patent applications, and publications cited herein are hereby incorporated by reference, to the extent that they provide exemplary, procedural or other details supplementary to those set forth herein.

1. A multifunctional cement additive comprising:
a biochelant; and
a solvent;
wherein the biochelant comprises a sodium glucarate liquid oxidation product comprising predominantly gluconate and glucarate anions with minor component species of n-keto-acids and C₂-C₅ diacids.

2. The multifunctional cement additive of claim 1, having a conductivity of from about 0.1 μS/cm² to about 25 μS/cm² as determined in accordance with ASTM G180 Polarization Resistance Test.

3. The multifunctional cement additive of claim 1, comprising at least three functionalities selected from the group consisting of water reducers, set retarders, accelerants, superplasticizers, corrosion inhibitors, and air entrainers.

4. The multifunctional cement additive of claim 1, further comprising a water reducer.

5. The multifunctional cement additive of claim 4, wherein the water reducer comprises lignosulfates, hydroxycarboxylic acid or a combination thereof.

6. The multifunctional cement additive of claim 1, further comprising a set retarder.

7. The multifunctional cement additive of claim 6, wherein the set retarder comprises lignosulfonates, welan gum, xanthan gum, cellulose, polyanionic cellulose, organic adds, alkali metal salts of organic adds, carboxy hexoses, carboxy lactones, polyvalent metal salts or a combination thereof.

8. The multifunctional cement additive of claim 1, further comprising an accelerant.

9. The multifunctional cement additive of claim 8, wherein the accelerant comprises calcium chloride, tricalcium silicate or a combination thereof.

10. The multifunctional cement additive of claim 1, further comprising a superplasticizer.

11. The multifunctional cement additive of claim 10, wherein the superplasticizer comprises phosphonic acid-terminated polyethers, naphthalenesulfonate polymer, formaldehyde polymer or a combination thereof.

12. The multifunctional cement additive of claim 1, further comprising a corrosion inhibitor.

13. The multifunctional cement additive of claim 12, wherein the corrosion inhibitor comprises nitrites, nitrates or a combination thereof.

14. The multifunctional cement additive of claim 1, further comprising an air entrainer.

15. The multifunctional cement additive of claim 14, wherein the air entrainer comprises natural wood resins, animal fats, wetting agents, water-soluble acid soaps or a combination thereof.

16. A cement composition comprising:
(i) a cementitious material;
(ii) a biochelant wherein the biochelant comprises a sodium glucarate liquid oxidation product comprising predominantly gluconate and glucarate anions with minor component species of n-keto-acids and C₂-C₅ diacids; and
(iii) a solvent.

17. The cement composition of claim 16, wherein the cementitious material comprises Portland cements, pozzolana cements, gypsum cements, phosphate cements, high alumina content cements, silica cements, high alkalinity cements, shale cements, acid/base cements, magnesia cements, fly ash cement, zeolite cement systems, cement kiln dust cement systems, slag cements, micro-fine cement, metakaolin, or a combination thereof.

18. The cement composition of claim 16, wherein the cementitious material is present in an amount of from about 0.01% BWOC to about 5% BWOC.

19. The cement composition of claim 16, wherein the biochelant is present is an amount of from about 0.1 wt. % to about 40 wt. % based on the total weight of the cement composition.

20. The cement composition of claim 16, wherein the solvent comprises fresh water or salt water.

21. The cement composition of claim 16, wherein the water is present in an amount of from about 20% BWOC to about 180% BWOC.

22. The cement composition of claim 16, having a compressive strength that is increased by from about 5% to about 100% when compared to an otherwise similar cement composition lacking a biochelant.

23. The cement composition of claim 16, having a thickening time that is increased by from about 5% to about 400% when compared to an otherwise similar cement composition lacking a biochelant.

24. The cement composition of claim 16, having a slump that is increased by from about 0.5 inches to about 9 inches when compared to an otherwise similar cement composition lacking a biochelant.
